(19) United States
(12) Patent Application Publication
(10) Pub. No.: US 2004/0145732 A1
(43) Pub. Date: Jul. 29, 2004

(54) Method for indicating a point in a measurement space

(76) Inventor: Esa Leikas, Espoo (FI)

Correspondence Address: Ronald R Santucci, Frommer Lawrence & Haug, 745 Fifth Avenue, New York, NY, 10151, US

(21) Appl. No.: 10/474,927

(22) PCT Filed: Apr. 15, 2002
(86) PCT No.: PCT/FI02/00318

(30) Foreign Application Priority Data
Apr. 19, 2001 (US) 20010808

(51) Int. Cl. G01C 1/00; G01B 11/26

(52) U.S. Cl. 356/141.2

(57) ABSTRACT

The present invention relates to a method for specifying a point in a measurement space. According to the invention, a measuring system (1) is calibrated to the same measurement space, the pointer is pointed at the point, using the coordinates of the point, and the position of the point thus pointed at is measured by a measuring system.

### FIELD OF THE INVENTION

The present invention relates to measuring technique. In particular, the invention relates to a method that can be used to measure a known point in a known object, or e.g. to check whether a reflecting surface exists at a given point in space and to determine the exact position of said surface.

### BACKGROUND OF THE INVENTION

In prior art, various methods for the measurement of a point on the surface of an object are known. Finnish patent no. 87951 discloses a method for specifying a point in three-dimensional space by means of two laser pointers. Traditionally, when a point on the surface of an object is to be measured, the object is accurately fixed to a jig and the measurement points are specified either by the method of the aforesaid patent specification or e.g. manually.

Finnish patent no. 74556 discloses a method for three-dimensional monitoring of a planar space. In this method, the space is observed by means of at least two image recording devices fitted at a distance from each other and at a fixed angle relative to each other, the pictures of the space received by these image recording devices are digitized and the target points are located in the image planes of the recording devices and, using the image coordinates of these target points and certain predetermined constants, the coordinates of the target points in the three-dimensional space under observation are calculated.

### OBJECT OF THE INVENTION

The object of the invention is to disclose a new type of method whereby a point in a measurement space can be quickly specified and measured. A specific object of the invention is to disclose a new type of method for specifying a point in an object located in a measurement space.

### BRIEF DETECTOR OF THE INVENTION

In the invention, a point is specified in a measurement space, said measurement space containing a point which is pointed at by a pointer, which pointer emits a pulse, and a reflection of this pulse is measured by a measuring system, and thus the position of the point having caused the reflection in the measurement space can be determined.

In an embodiment of the invention, a measuring system according to patent specification 74556 is calibrated as instructed by said specification to a three-dimensional measurement space and a laser pointer according to patent specification 87951 is calibrated to this same space so that a relation, a mathematical model is formed between this laser pointer and the measuring system, which relation or model can be used to calculate the pointer position required when the pointer is to point through a given point in the measurement space. This mathematical model, as well as the commands needed to control the pointer and the equations needed in the processing of the data obtained from the measuring system, are preferably programmed on a computer. The measuring system preferably measures the position of the object in space, and a computing unit, using the relation between the object's position, the pointer and the measurement space, the coordinates of the point in the model of the object, calculates the coordinates to be sent to the pointer. This calculation consists of simple coordinate conversion, and it will not be dealt with in detail in the present application. A prerequisite in this preferred embodiment is that a model of the object be somehow previously known. The model may consist of e.g. a CAD model or a model in a form that the computing unit is able to process.

According to a preferred embodiment of the invention, the distance between the point pointed at and the pointer is measured e.g. on the fathometer principle, whereby the reflection time of the signal sent by the pointer is measured and the distance of the reflecting point from the pointer is calculated from the reflection time and the signal velocity, which is e.g. a known natural constant, c. As the position of the pointer relative to the measuring system is known, this distance can be used for checking or adjusting the coordinates of the measured point.

By the method of the invention, it is easy to quickly establish whether a reflecting surface exists at a given location in a measurement space. On the other hand, it is possible to measure, without a jig or equivalent, one or more points in an object and thus to establish their absolute position or e.g. the precision of a component. In addition, as the method allows the use of e.g. a CAD model or an equivalent computer-readable model, the object to be measured can be replaced quickly and, for instance, each object to be measured may be different. The method can be applied as an element of quality control in production where cycle times are short but where several points in different locations in the objects being manufactured can be measured within the cycle time. Also, e.g. when several points at equal distances on the surface of a complex object are to be measured, this can be easily achieved by determining these points in a model of the object and converting the coordinates into a pointer space to suit the pointer.

### DETAILED DESCRIPTION OF THE INVENTION

In the following, the invention will be described in detail by the aid of examples of its embodiments with reference to the attached drawing, which is a diagrammatic representation of a method according to the invention.

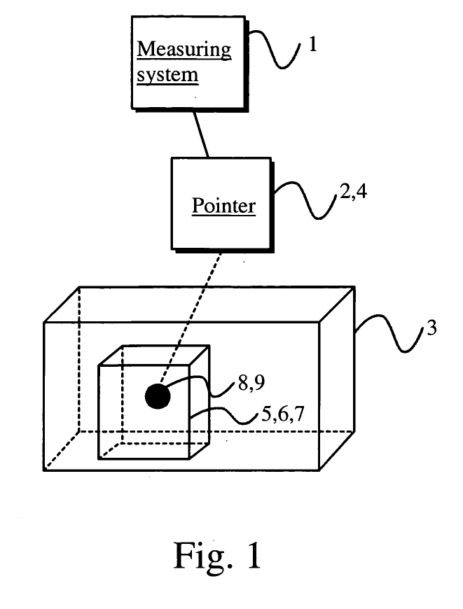

FIG. 1 presents a measuring system 1 consisting of two cameras and a computing unit connected to them. The computing unit contains the means required for the processing of the information provided by the cameras. Typically, the cameras are digital cameras, and there may be two or more of them. The computing unit contains the required data for the processing of the information obtained from the cameras and for creating a three-dimensional model based on this information. A measuring system according to an embodiment of the present invention corresponds to the arrangement described in Finnish published patent application 74556, yet the invention is not limited to the embodiment presented here, but all measuring systems suited for three-dimensional monitoring of a measurement space are applicable.

The cameras can record e.g. visible light, infrared light or some other electromagnetic radiation, or sound or any undulating motion. However, the undulating motion measured by the measuring system is such that, when the pointer is pointing at a given point, either this undulating motion is reflected back from the point being pointed at or the pointing causes this point to radiate such undulating motion, e.g. by fluorescence.

The calibration of a measuring system to a measurement space is known in prior art and it will not be dealt with in detail in this application. Provided in conjunction with this same computing unit 4 is a pointer 2. This pointer comprises at least a radiation source, preferably a laser, and means for adjusting the directional angle of the radiation beam, allowing the radiation beam to be aligned in the target space. The pointer may also be an infrared, ultraviolet violet or ultrasound pointer, or any pointer. The pointer is also connected to the computing unit. The position of the pointer can be adjusted. According to the invention, the pointer is calibrated to the measuring system. The calibration is carried out by directing the pointer to several points in the measurement space, the exact positions of which points are either known or they are measured by the measuring system. The angle and attitude of the pointer are also measured as it is pointing at the aforesaid points. When both the pointer attitude and the positions of these points in the measurement space according to the measuring system are known and there are at least three of such points, it is possible to form a mathematical equation for converting a point of the three-dimensional measurement space into a point of the two-dimensional pointer space. It is to be noted that the pointer space is preferably a pointer-centered spherical polar coordinate system where the only variables are α and β, i.e. two angles, while the pointer beam is a ray, and this ray can be omitted from the coordinate conversion.

In a preferred embodiment, a rectangular [coordinate system] is used, in other words, the coordinates (x,y) obtained from the laser pointer are like image coordinates obtained from a camera. In this case, instead of an angle, a value is obtained that corresponds to the intersection (x,y) between the ray and an imaginary plane placed in front of the pointer. This makes it easier to control the situation when the rays produced by the laser pointer at different angles do not intersect at the same point. This is almost always the case in mirror scanners. As the relation between the measurement space and the pointer space is known, it is stored on the computing unit and the coordinate conversions can be made automatically.

According to a preferred embodiment of the invention, the method is used for measuring a point in given part of space. In this embodiment, the pointer is so directed that it penetrates this part of space and a measurement is made by the measuring system to establish whether the ray emitted by the pointer has been reflected from this part, and the position of the reflected ray is measured. This embodiment can be used e.g. for the verification of installation. According to a second embodiment of the invention, the measurement space is part a quality control system where the object to be monitored is at least partially within the measurement space, where its exact position is determined by the measuring system, whereupon the pointer can be pointed at a desired point or desired points in the object, the exact positions of which can be measured. A prerequisite for this is that a model of the object be known in some way so that, after the position of the object has been determined, a coordinate conversion can be performed by the measuring system when the coordinates of the points to be measured in the model of the object are known.

The coordinate conversion is made from the coordinates of the model of the object to the measurement space and further to the pointer space. The model of the object may be any kind of model, preferably a model that can be stored on a computer, in which case the model can be quickly replaced and the object under measurement can also be quickly replaced with a different object.

This embodiment can also be combined with pattern recognition, where an object is recognized and a model is selected on the basis of the recognition, whereupon desired points in this object are measured on the basis of the model selected by pattern recognition. According to a preferred embodiment of the invention, a number of pointers are used and they are all calibrated to the measurement space of the measuring system. With these pointers, different points in an object can be pointed at simultaneously when the measuring system is to produce an image of e.g. the entire object. It is to be noted that, since the tolerances in the objects to be measured are generally not very large and therefore the coordinates of the place pointed at by the pointer can be expected to be found very close to the coordinates determined by the original model, the calculation of the positions of the measured points can be only performed using that part of the data that the measuring system provides from the vicinity of these places. Thus, the points pointed at by different pointers can be easily distinguished from each other when the data provided by the measuring system is being processed by a computer, and no large or superfluous amounts of data are processed, which means faster processing and therefore faster measurement.

According to a preferred embodiment of the invention, the time of passage of the pulse emitted by the pointer to the point pointed at and further to a known place in the measurement space, e.g. back to the pointer, is measured and, based on this time and the velocity of advance of the pulse, e.g. a natural constant, the exact distance of the point from the known part of the measurement space is determined. This distance can be utilized for checking or adjusting the position of the point calculated on the basis of the data provided by the measuring system.

The invention is not restricted to the examples of its embodiments described above; instead, many variations are possible within the scope of the inventive idea defined in the claims.

1. Method for specifying a point (8) in a measurement space (3), characterized in that the method comprises the steps of:
calibrating a measuring system (1) to a three-dimensional measurement space (3),
calibrating a pointer (2) to the same measurement space (3),
pointing the pointer (2) at the point (8), using the coordinates of the point, and
measuring the position of the point (9) thus pointed at, using the measuring system (1).

2. Method according to claim 1, characterized in that, to calibrate the pointer (2), the pointer (2) is pointed at a spot in the measurement space (3), and the position of said spot is measured by the measuring system (1).

3. Method according to claim 1 or 2, characterized in that, in the calibration of the pointer (2), the position of the pointer (2) relative to the measuring system is determined.

4. Method according to claim 3, characterized in that, using the position data of the pointer (2), an equation for converting the coordinate system of the measurement space (3) into a pointer-centered spherical polar coordinate system is formed.

5. Method according to claim 3, characterized in that, using the position data of the pointer (2), an equation for converting the coordinate system of the measurement space (3) into a rectangular coordinate system is formed.

6. Method according to any one of the preceding claims, characterized in that the point (8) is comprised in an object (5), a model (6) of which and the location (7) of which in the measurement space (1) are at least partially known.

7. Method according to claim 6, characterized in that the position (7) of the object (5) is measured by the measuring system (1).

8. Method according to claim 7, characterized in that the coordinates of the point (8) in the measurement space (1) are calculated on the basis of the position (7) of the object (5) in the measurement space (1) and the position of a point corresponding to said point (8) in the model (6) of the object (5).

9. Method according to any one of claims 5-7, characterized in that the model (6) of the object (5) is a CAD model.

10. Method according to any one of the preceding claims, characterized in that two or more pointers (2) are used.

11. Method according to any one of the preceding claims, characterized in that the calculations are performed using a computer that is capable of transmitting data to the pointer (2) and receiving data from the measuring system (1).

12. Method according to any one of the preceding claims, characterized in that the pointer (2) is one that uses white light.

13. Method according to any one of the preceding claims, characterized in that the distance of the point pointed at from the pointer is measured on the fathometer principle, and this information is used for adjusting the position data of the point pointed at.

14. Method according to any one of the preceding claims, characterized in that the measuring system (1) is an optical camera system.

15. Method according to any one of the preceding claims, characterized in that the pointer (2) points at several points in the target simultaneously.
